(19) United States
(12) Patent Application Publication
(10) Pub. No.: US 2026/0260787 A1
(43) Pub. Date: Sep. 3, 2026

(54) CABLE WITH CONNECTOR

(71) Applicant: SUMITOMO ELECTRIC INDUSTRIES, LTD., Osaka (JP)

(72) Inventors: Naoshige YOKOTA, Tochigi (JP); Takaaki OKAMOTO, Tochigi (JP); Yuji OCHI, Tochigi (JP)

(21) Appl. No.: 18/718,198

(22) PCT Filed: Nov. 1, 2023
(86) PCT No.: PCT/JP2023/039504

§ 371 Date: Jun. 10, 2024

(30) Foreign Application Priority Data
Nov. 2, 2022 (JP) 2022-176174

(51) Int. Cl. H01B 11/18; H01B 1/02

(52) U.S. Cl. CPC H01B 11/1895; H01B 1/02; H01B 11/1808

(57) ABSTRACT

A connector-equipped cable (10) including a connector (11) and a cable (20), wherein: the cable (20) includes a plurality of electric wires (21) including a coaxial electric wire (22); the coaxial electric wire (22) includes a center conductor (221) that is an unplated soft copper wire and has a conductor cross sectional area of 0.031 mm² to 0.06 mm²; the connector (11) includes a substrate (111); the cable (20) is connected to a contact point (1111) of the substrate (111); and the coaxial electric wire (22) has an attenuation of 5.1 dB/m to 8.1 dB/m.

### TECHNICAL FIELD

The present disclosure relates to a cable with connector.

This application claims priority based on Japanese Patent Application No. 2022-176174 filed on Nov. 2, 2022, and the entire contents of the Japanese patent application are incorporated herein by reference.

### BACKGROUND ART

Patent literature 1 discloses a multi-core cable including at least two pairs of electric wires each including two electric wires, at least two insulated electric wires, and a sheath covering the electric wire pairs and the insulated electric wires, wherein the electric wire pairs are arranged on the same circumference in a cross-section perpendicular to a longitudinal direction of the cable, and each insulated electric wire is arranged in contact with one of the electric wire pair.

### CITATION LIST

### Patent Literature

Patent literature 1: Japanese Unexamined Patent Application Publication No. 2017-4594

### SUMMARY OF THE INVENTION

A cable with a connector according to the present disclosure includes the connector and the cable, wherein the cable includes a plurality of electrical wires including a coaxial electrical wire, wherein the coaxial electrical wire includes a central conductor being an annealed copper wire that is not plated and having a conductor cross-sectional area of 0.031 mm² to 0.06 mm², wherein the connector includes a substrate, and the cable is connected to a contact part of the substrate, and wherein an attenuation of the coaxial electrical wire is 5.1 dB/m to 8.1 dB/m.

### BRIEF DESCRIPTION OF THE DRAWINGS

FIG. 1A is an illustration of a cable with connector in accordance with an aspect of the present disclosure.

FIG. 1B is an illustration of a cable with connector in accordance with an aspect of the present disclosure.

FIG. 2 is a cross-sectional view taken along line A-A′ of FIGS. 1A and 1B.

FIG. 3 is a cross-sectional view of a coaxial electrical wire of a cable with connector according to an embodiment of the present disclosure.

### DETAILED DESCRIPTION

### Problems to be Solved by Present Disclosure

With the recent increase in speed and capacity of information communication, the frequency band used has been increased. Since attenuation increases as the frequency band used increases, cables are required to reduce attenuation more than before.

Therefore, an object of the present disclosure is to provide a cable with connector including a coaxial electrical wire in which attenuation is reduced.

### Advantageous Effects of Present Disclosure

According to the present disclosure, a cable with connector including a coaxial electrical wire with reduced attenuation can be provided.

Embodiments will be described below.

### Description of Embodiments of Present Disclosure

First, embodiments of the present disclosure will be listed and described. In the following description, the same or corresponding elements are denoted by the same reference numerals, and the same description thereof will not be repeated.

(1) A cable with a connector according to one embodiment of the present disclosure, includes the connector, and the cable. The cable includes a plurality of electrical wires including a coaxial electrical wire. The coaxial electrical wire includes a central conductor being an annealed copper wire that is not plated and having a conductor cross-sectional area of 0.031 mm² to 0.06 mm². The connector includes a substrate, and the cable is connected to a contact part of the substrate. An attenuation of the coaxial electrical wire is 5.1 dB/m to 8.1 dB/m.

By setting the conductor cross-sectional area of the central conductor of the coaxial electrical wire to be 0.031 mm² to 0.06 mm², the coaxial electrical wire can be made compact while performing high-speed digital transmission.

Further, by using an annealed copper wire that is not plated, that is, a bare annealed copper wire as the central conductor, a cable with connector including a coaxial electrical wire in which attenuation is reduced can be provided.

(2) A cable with a connector according to an embodiment of the present disclosure, includes the connector, and the cable. The cable includes a plurality of electrical wires including a coaxial electrical wire. The coaxial electrical wire includes a central conductor being an annealed copper wire that is not plated and having a conductor cross-sectional area of 0.07 mm² to 0.13 mm². The connector includes a substrate, and the cable is connected to a contact part of the substrate. An attenuation of the coaxial electrical wire is 4.0 dB/m to 5.0 dB/m

By setting the conductor cross-sectional area of the central conductor of the coaxial electrical wire to be 0.07 mm² to 0.13 mm², the coaxial electrical wire can be made compact while performing high-speed digital transmission.

Further, by using an annealed copper wire that is not plated, that is, a bare annealed copper wire as the central conductor, a cable with connector including a coaxial electrical wire in which attenuation is reduced can be provided.

(3) A cable with a connector according to an embodiment of the present disclosure, includes the connector, and the cable. The cable includes a plurality of electrical wires including a coaxial electrical wire. The coaxial electrical wire includes a central conductor being an annealed copper wire that is not plated and having a conductor cross-sectional area of 0.01 mm² to 0.025 mm². The connector includes a substrate, and the cable is connected to a contact part of the substrate. An attenuation of the coaxial electrical wire is 10 dB/m to 12 dB/m.

By setting the conductor cross-sectional area of the central conductor of the coaxial electrical wire to be 0.01 mm² to 0.025 mm², the coaxial electrical wire can be made compact while performing high-speed digital transmission.

Further, by using an annealed copper wire that is not plated, that is, a bare annealed copper wire as the central conductor, a cable with connector including a coaxial electrical wire in which attenuation is reduced can be provided.

(4) In any one of the above (1) to (3), the cable may include at least one pair of coaxial electrical wires. A skew of the pair of coaxial electrical wires may be 10 ps/m or less.

Since the cable includes at least one pair of coaxial electrical wires, the cable allows the pair of coaxial electrical wires to be utilized in differential transmission applications.

(5) In any one of the above (1) to (4), the cable may include a core constituted by twisting together the plurality of electrical wires, a common shielding layer disposed outside the core, and an outer covering disposed outside the common shielding layer.

Since the cable has the common shielding layer, it is possible to suppress noise from being superimposed on a signal propagated by the electrical wire, particularly the coaxial electrical wire. In addition, the influence of noise on external devices can be reduced.

Further, since the cable has the outer covering, the electrical wires and the common shielding layer disposed inside can be protected.

(6) In any one of the above (1) to (5), the coaxial electrical wire may include an external conductor disposed outside the central conductor, and the external conductor may include an annealed copper wire that is not plated.

When the external conductor includes the annealed copper wire that is not plated, the attenuation of the coaxial electrical wire including the external conductor can be particularly reduced as compared with a case where the external conductor includes a tin-plated annealed copper wire.

### Details of Embodiments of Present Disclosure

A specific example of a cable with connector according to one embodiment of the present disclosure (hereinafter referred to as “the embodiment”) will be described below with reference to the drawings. The present invention is not limited to these examples, but is defined by the scope of the claims, and is intended to include all modifications within the meaning and scope equivalent to the scope of the claims.

In this specification, first, second, or the like may be added to the names of members, such as first cover and second cover. The terms “first”, “second”, or the like are used only to distinguish the respective members and to prevent confusion in the description, and do not represent arrangement, priority, or the like. Therefore, when there is no particular possibility of confusion or when the description is made collectively, the term “cover” can be used.

[Cable with Connector]

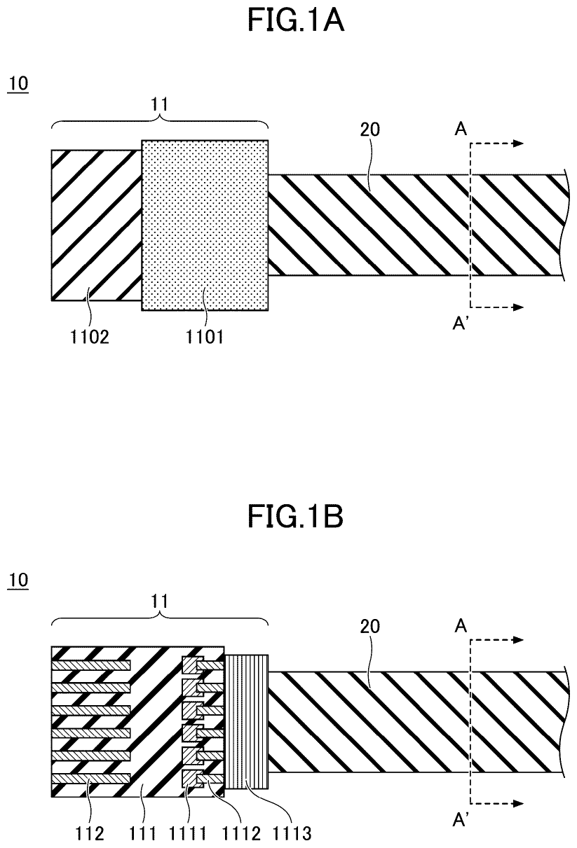

FIG. 1A shows a top view of the periphery of the connector of a cable with connector 10 of the embodiment. FIG. 1B shows a top view of the periphery of a substrate 111 inside the connector for cable with connector 10 of the embodiment. In FIG. 1B, a cover is omitted so that the connection state between the connector and a cable 20 can be seen. Although not shown, a region 1113 of FIG. 1B is a portion where electrical wires coming out of cable 20 are aligned.

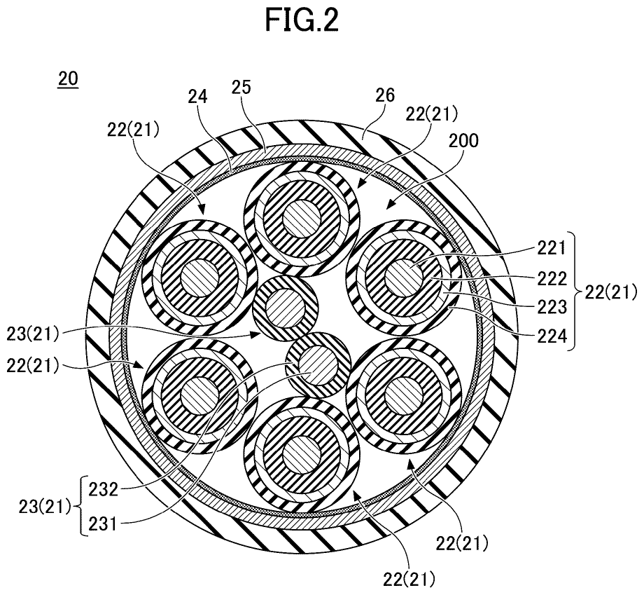

FIG. 2 shows a configuration example of a cross-section perpendicular to the longitudinal direction of cable 20 included in cable with connector 10 of the embodiment. FIG. 2 is a cross-sectional view taken along line A-A′ of FIGS. 1A and 1B.

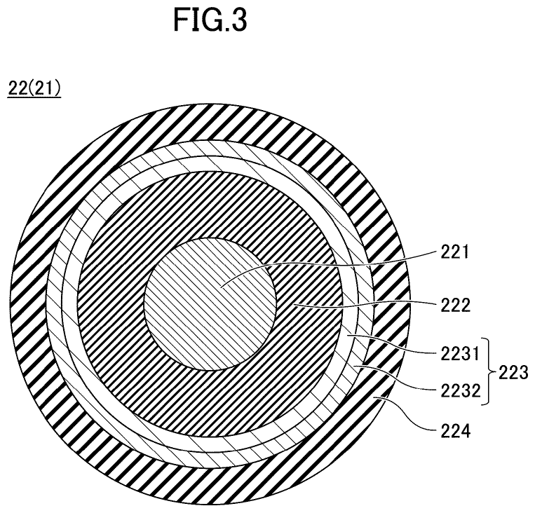

FIG. 3 is an illustration of a cross-section perpendicular to the longitudinal direction of the coaxial electrical wire of cable 20.

Note that FIGS. 1A to 3 are schematic views shown for explaining a configuration example of cable with connector 10 of the embodiment, and the size, the number of members, the arrangement, or the like are not limited to such a form.

As shown in FIGS. 1A and 1B, cable with connector 10 of the embodiment includes a connector 11 and cable 20.

As shown in FIG. 1A, connector 11 includes a first cover 1101 that houses and protects the periphery of a connection portion between cable 20 and the substrate, and a second cover 1102 that houses and protects the periphery of terminals connected to another device. The configuration of the cover of connector 11 is not limited to the above embodiment, and can be any configuration depending on the type of the connector.

FIG. 1B is a diagram when first cover 1101 and second cover 1102 are removed. As shown in FIG. 1B, connector 11 has substrate 111. Substrate 111 connects a terminal 112 and cable 20. Cable 20, specifically, a conductor 1112 of an electrical wire included in cable 20 is connected to a contact part 1111 of substrate 111. Conductor 1112 and contact part 1111 are electrically connected to each other by, for example, soldering.

Although the wiring of substrate 111 is not shown in FIG. 1B, the wiring is arranged so as to electrically connect terminal 112 of connector 11 and contact part 1111.

Each member included in the cable with connector of the embodiment will be described.

### (1) Connector:

Connector 11 can include terminal 112 for connecting cable 20 to another device, and substrate 111. The configuration of terminal 112 is not limited to a particular one, and terminal 112 can have any configuration according to the type of the connection partner, the required use, the device to be connected, or the like.

In order to protect substrate 111, the wiring on substrate 111, contact part 1111, or the like, various covers and the like shown in FIG. 1A can be provided.

### (2) Cable:

Cable 20 can have a plurality of electrical wires 21 as shown in FIG. 2. The plurality of electrical wires 21 can include coaxial electrical wires 22.

### (2-1) About the Electrical Wire and the Core of the Cable:

### (2-1-1) Coaxial Electrical Wire:

Cable 20 can have coaxial electrical wire 22 as electrical wire 21.

Cable 20 can include a pair of coaxial electrical wires 22. That is, cable 20 can include at least one pair of coaxial electrical wires 22. Cable 20 can use the pair of coaxial electrical wires 22 for differential transmission applications.

Two coaxial electrical wires 22 constituting a pair may be disposed close to each other. Coaxial electrical wires 22 constituting the pair do not need to be twisted.

Coaxial electrical wire 22 can have a cross-section perpendicular to the longitudinal direction thereof, which has a structure shown in FIGS. 2 and 3. That is, coaxial electrical wire 22 can include a central conductor 221, an insulator 222 disposed outside central conductor 221, an external conductor 223 disposed outside insulator 222, and an outer covering 224 disposed outside external conductor 223. Hereinafter, each member of coaxial electrical wire 22 will be described.

### (A) Central Conductor:

### (Size)

Coaxial electrical wire 22 can be thinner than American Wire Gauge (AWG) 25. Coaxial electrical wire 22 may be, for example, any one of small-diameter coaxial electrical wires of AWG 26 to AWG 36.

Therefore, the conductor cross-sectional area of central conductor 221 of coaxial electrical wire 22 can be set to be 0.01 mm² to 0.13 mm², and may be 0.031 mm² to 0.06 mm².

By setting the conductor cross-sectional area of central conductor 221 of coaxial electrical wire 22 to be 0.01 mm² to 0.13 mm², coaxial electrical wire 22 can be made compact while performing high-speed digital transmission.

An outer diameter of central conductor 221 can be, for example, 0.45 mm or less, and may be 0.07 mm to 0.45 mm.

Central conductor 221 may be a stranded wire constituted by twisting together a plurality of conductor wires or may be a single wire.

### (Material)

In the conventional cable, tin-plated soft copper is often used as a central conductor of a coaxial electrical wire. However, according to studies conducted by the present inventors, attenuation can be reduced by using an annealed copper wire that is not plated, that is, a bare annealed copper wire as central conductor 221, as compared with the case where tin-plated soft copper is used as the central conductor. Therefore, coaxial electrical wire 22 of the cable with connector of the embodiment can be an annealed copper wire including central conductor 221 that is not plated. By using an annealed copper wire that is not plated, that is, a bare annealed copper wire as central conductor 221, a cable with connector including a coaxial electrical wire in which attenuation is reduced can be provided.

Specifically, by using a bare annealed copper wire for central conductor 221, attenuation of coaxial electrical wire 22 according to the conductor cross-sectional area of the central conductor can be set within a predetermined range, as described below. The following attenuation is the attenuation of coaxial electrical wire 22 alone without the connector.

When the conductor cross-sectional area of the central conductor is 0.031 mm² to 0.06 mm², an attenuation of coaxial electrical wire 22 can be 5.1 dB/m to 8.1 dB/m.

When the conductor cross-sectional area of the central conductor is 0.07 mm² to 0.13 mm², the attenuation of coaxial electrical wire 22 can be 4.0 dB/m to 5.0 dB/m.

Further, when the conductor cross-sectional area of the central conductor is 0.01 mm² to 0.025 mm², the attenuation of coaxial electrical wire 22 can be 10 dB/m to 12 dB/m.

According to studies conducted by the present inventors, when the tin-plated annealed copper wire is used as central conductor 221 and the conductor cross-sectional area of each of the central conductors is within the above described range, the attenuation of coaxial electrical wire 22 often exceeds the above described range. Attenuation in this specification means attenuation in 10 GHz.

As described above, cable 20 can also include a pair of two electrical wires, i.e., a pair of coaxial electrical wires 22. In addition, by using a bare annealed copper wire as central conductor 221 of coaxial electrical wire 22, it is possible to suppress a skew of the pair of coaxial electrical wire 22. To be specific, by using a bare annealed copper wire as central conductor 221, the skew of the pair of coaxial electrical wires 22 can be reduced to, for example, 10 ps/m or less. According to studies conducted by the present inventors, when the tin-plated annealed copper wire is used as central conductor 221, the skew of the pair of coaxial electrical wire 22 exceeds 10 ps/m.

### (B) Insulator

The material of insulator 222 is not limited to a particular one. Insulator 222 can include a polymer material. Examples of the polymer material include one or more selected from polyethylene, fluororesins such as tetrafluoroethylene-hexafluoropropylene copolymer (FEP), tetrafluoroethylene-ethylene copolymer (ETFE), and polytetrafluoroethylene (PFA), and polymethylpentene.

Insulator 222 can also contain various additives such as a flame retardant in addition to the polymer material.

The material of insulator 222 may be cross-linked or not cross-linked.

Insulator 222 can be formed by extrusion molding or the like of a raw material containing a polymer material around central conductor 221. An outer diameter of insulator 222 can be, for example, 0.2 mm to 1.0 mm.

### (C) External Conductor

Coaxial electrical wire 22 can have external conductor 223 disposed outside central conductor 221. Specifically, external conductor 223 is disposed outside central conductor 221 to dispose insulator 222 between external conductor 223 and central conductor 221. Since coaxial electrical wire 22 include external conductor 223, it is possible to block the entry of noise from the outside into central conductor 221 and the emission of noise from central conductor 221 to the outside.

External conductor 223 can be formed of a single layer of external conductor, or can be formed of two or more layers of external conductors. In particular, from the viewpoint of improving the noise sheltering effect of coaxial electrical wire 22, external conductor 223 can include two or more layers of external conductors. However, from the viewpoint of productivity or the like, external conductor 223 may be formed of two layers.

External conductor 223 can include, for example, a first external conductor 2231 and a second external conductor 2232 as shown in FIG. 3.

External conductor 223 includes first external conductor 2231 and second external conductor 2232, and thus high noise sheltering effect can be achieved as compared with the case where only one type of external conductor is used.

A configuration example in which external conductor 223 has two layers of first external conductor 2231 and second external conductor 2232 will be described below.

### (C-1) First External Conductor:

First external conductor 2231 can include a thin metal strand made of a metallic material such as copper, copper alloy, aluminum, or aluminum alloys, or a material obtained by plating the surface of the metallic material. As the metal strand, an annealed copper wire, a hard drawn copper wire, or the like can be used. The metal strand may be plated on the surface as described above, and examples of the plating include silver and tin. Therefore, as the metal strand, a silver-plated annealed copper wire, a tin-plated annealed copper wire, or the like can be used.

External conductor 223 can also include an annealed copper wire that is not plated. Since external conductor 223 includes the annealed copper wire that is not plated, attenuation of coaxial electrical wire 22 including external conductor 223 can be reduced as compared with the case where external conductor 223 includes a tin-plated annealed copper wire. Therefore, metal thin wires included in first external conductor 2231 can include an annealed copper wire that is not plated. The metal thin wires can each be constituted by an annealed copper wire that is not plated.

First external conductor 2231 can be formed by helically winding or braiding one or more above-mentioned metal strands.

### (C-2) Second External Conductor:

Second external conductor 2232 can be a film-like member having a metal layer, for example. Second external conductor 2232 can block the entry of noise from the outside into central conductor 221 and the emission of noise from central conductor 221 to the outside due to the presence of the metal layer.

Examples of the metal layer of second external conductor 2232 include a metal foil and a metal film (vapor deposition layer). Second external conductor 2232 may be formed of a metal layer alone or a composite material in which a metal layer is laminated on a base material.

When second external conductor 2232 is a film-like member having a metal layer as described above, the material of the metal layer is not limited to a particular one, and examples thereof include metallic materials such as copper, copper alloy, aluminum, and aluminum alloys. The metal layer may be formed of a layer of a single metal species or be formed by stacking layers of two or more metal species. Further, a material other than metal, such as a protective film made of an organic material, may be disposed on the surface of the metal layer as necessary.

Second external conductor 2232 can also have a base material as described above. The material of the base material is not limited to a particular one. Examples of the material of the base material include polyester resins such as polyethylene terephthalate (PET), polyolefin resins such as polypropylene, and vinyl resins such as polyvinyl chloride. The base material can contain various additives in addition to various polymer materials. As the polymer material, a polyester resin can be suitably used from the viewpoint of excellent mechanical strength and flexibility.

### (D) Outer Covering:

Outer covering 224 can include a polymer material. The polymer material can be one or more selected from polyethylene, polyvinyl chloride (PVC), and fluororesins such as FEP.

Outer covering 224 can contain various additives such as a flame retardant in addition to the polymer material.

The material of outer covering 224 may be cross-linked or not cross-linked.

Outer covering 224 can be formed by extrusion molding or the like of a raw material containing a polymer material around external conductor 223. Outer covering 224 can be formed by winding a resin tape of polyester resin such as polyethylene terephthalate around the outer periphery of external conductor 223.

An outer diameter of outer covering 224 can be, for example, 0.3 mm to 1.2 mm.

### (2-1-2) Insulating Electrical Wire:

Cable 20 of cable with connector 10 of the embodiment can include the plurality of electrical wires 21. As described above, at least a part of electrical wires 21 can be coaxial electrical wires 22.

Cable 20 can also include an insulating electrical wire 23 as electrical wire 21. Insulating electrical wire 23 include a conductor 231 and an insulator 232 disposed outside conductor 231.

### (A) Conductor:

Conductor 231 may be a stranded wire constituted by twisting together the plurality of conductor wires or may be a single wire.

The material of conductor 231 is not limited to a particular one, and for example, a copper alloy or copper can be used. Annealed copper can be used as the copper. Conductor 231 may be an annealed copper wire that is not plated.

An outer diameter of conductor 231 is not limited to a particular one, but can be, for example, 0.1 mm to 0.8 mm.

### (B) Insulator:

The material of insulator 232 is not limited to a particular one. Insulator 232 can include a polymer material. The polymer material may be one or more selected from polyethylene, polyvinyl chloride, and fluororesins such as FEP.

Insulator 232 can also contain various additives such as a flame retardant in addition to the polymer material.

The material of insulator 232 may be cross-linked or not cross-linked.

Insulator 232 can be formed by extrusion molding or the like of a raw material containing a polymer material around conductor 231. An outer diameter of insulator 232 can be, for example, 0.2 mm to 1.2 mm.

### (2-1-3) Core:

The number and configuration of electrical wires 21 of cable 20 are not limited to a particular one, and can be selected as desired according to the characteristics and the like required for cable 20. Although FIG. 2 shows an example of cable 20 having one kind of coaxial electrical wire 22 having the same configuration and one kind of insulating electrical wire 23 having the same configuration, cable 20 is not limited to such a form. For example, the cable may be include coaxial electrical wire 22 and insulating electrical wire 23 each including two or more types of wires having different configurations such as outer diameters and different materials. Further, some or all of insulating electrical wires 23 may be a pair of twisted insulating electrical wires made by twisting two wires as one set.

The plurality of electrical wires 21 of cable 20 can be also collectively twisted and assembled in a spiral shape to constitute a core 200. That is, cable 20 can have core 200 in which the plurality of electrical wires 21 including coaxial electrical wire 22 are twisted together.

The arrangement of electrical wires 21 in core 200 is not limited to a particular one. For example, as shown in FIG. 2, coaxial electrical wires 22 that are paired can be arranged on the same circumference in a cross-section perpendicular to the longitudinal direction of cable 20. Coaxial electrical wires 22 of cable 20 may be arranged such that central conductors 221 are positioned on the same circumference. However, the expression “on the same circumference” does not have a geometrically strict meaning, and central conductor 221 may be shifted from the circumference due to, for example, manufacturing errors or movement of the electrical wire during use. The circle may be an ellipse instead of a perfect circle.

A filler including a tensile strength fiber made of a large number of aramid fibers, a staple fiber thread, or the like may be disposed between electrical wires 21 constituting core 200 as necessary.

### (2-2) Other Members Included in Cable:

### (2-2-1) Securing Windings:

Securing windings 24 can be provided around core 200.

Cable 20 includes securing windings 24, and thus electrical wires 21 included in cable 20 can be stably arranged and bundled.

As securing windings 24, for example, a resin tape can be used.

The resin used for the resin tape may be one or more selected from a fluororesin such as a polytetrafluoroethylene (PTFE) resin, a polyester resin such as a polyethylene terephthalate (PET) resin, polyethylene (PE), or the like, which are excellent in heat resistance, abrasion resistance, or the like.

The resin tape used as securing windings 24 can contain a conductive material such as carbon in order to have conductivity. The conductive material can be added to the resin constituting the resin tape so as to be dispersed therein. Alternatively, a metal tape obtained by disposing a copper foil or an aluminum foil on the surface of the resin tape may be used.

A winding direction of securing windings 24 may be the same direction as a twisting direction of electrical wire 21 constituting core 200 or may be the opposite direction. As securing windings 24, a metal tape made of copper foil, aluminum foil, or the like can be used instead of the resin tape.

Since cable 20 has securing windings 24, it is possible to prevent outer covering 224 and insulator 232 included in electrical wire 21 included in core 200 from being damaged when a common shielding layer 25 described later is disposed outside core 200. When securing windings 24 have conductivity, the influence of noise on or from an external device which is a device outside cable 20 can be suppressed. In addition, since securing windings 24 has conductivity, attenuation of a signal transmitted by electrical wire 21 can be particularly reduced.

### (2-2-2) Common Shielding Layer:

Cable 20 can have common shielding layer 25 disposed outside core 200.

As described above, another member such as securing windings 24 can be disposed between core 200 and common shielding layer 25.

Common shielding layer 25 can include a thin metal strand made of a metallic material such as copper, copper alloy, aluminum, aluminum alloys, or a material obtained by plating the surface of the metallic material. As the metal strand, an annealed copper wire, a hard drawn copper wire, or the like can be used. The metal strand may be plated on the surface as described above, and examples of the plating include silver and tin. Therefore, as the metal strand, a silver-plated annealed copper wire, a tin-plated annealed copper wire, or the like can be used.

Common shielding layer 25 can be formed by, for example, helically winding or braiding one or more above-mentioned metal thin wires.

Since cable 20 has common shielding layer 25, it is possible to suppress noise from being superimposed on a signal propagated by electrical wire 21, particularly, coaxial electrical wire 22. In addition, the influence of noise on external devices can be suppressed.

### (2-2-3) Outer Covering:

Cable 20 can have an outer covering 26 disposed outside common shielding layer 25.

The material of outer covering 26 is not limited to a particular one. Outer covering 26 can include a polymer material. Examples of the polymer material include polyolefins such as polyethylene, polyvinyl chloride (PVC), and thermoplastic elastomers (TPE).

Outer covering 26 can contain various additives such as a flame retardant in addition to the polymer material.

The material of outer covering 26 may be cross-linked or not cross-linked.

An outer diameter of outer covering 26 can be, for example, 2.0 mm to 6.0 mm.

Since cable 20 has outer covering 26, electrical wires 21 disposed inside and common shielding layer 25 can be protected.

### (2-3) Length of Cable:

The length of the cable of the cable with connector of the embodiment, that is, the length along the longitudinal direction is not limited to a particular one. For example, the lengths of the coaxial electrical wires and the cables including the coaxial electrical wires can be selected so that the attenuation of the coaxial electrical wires included in the cable with connector, together with the connector, is 7.5 dB or less.

For example, when attenuation of coaxial electrical wires included in a cable with connector, together with connector, is set to 7.5 dB or less a cable including coaxial electrical wires having attenuation of 13 dB/m is used. When the cable is designed such that the attenuation of the coaxial electrical wire with respect to the cable alone without the connector is 6 dB or less, the cable including the coaxial electrical wire can be 0.46 m or less.

### Example

The present invention will be described below with reference to specific examples, but the present invention is not limited to these examples.

### (Evaluation Method)

First, a method for evaluating cables produced in the following experimental examples will be described.

### (1) Attenuation:

In a cable with connector in which USB Type-C connectors were attached to both ends of a cable including a coaxial electrical wire having a length of 1 m produced in the following experimental examples, attenuation of the coaxial electrical wire and the connectors was measured using a network analyzer (manufactured by Agilent Technologies). The evaluation result is shown in the column of “attenuation” in Table 1.

Further, attenuation of the coaxial electrical wire was measured with respect to a cable alone without a connector, which was produced in the following experimental example and had a length of 1 m. The evaluation result is shown in the column of “attenuation of isolated cable” in Table 1.

### Experimental Example

Experimental example 1-1, experimental example 2-1, experimental example 3-1, experimental example 4-1, and experimental example 5-1 are examples, and experimental example 1-2, experimental example 1-3, experimental example 2-2, experimental example 2-3, experimental example 3-2, experimental example 3-3, experimental example 4-2, experimental example 4-3, experimental example 5-2, and experimental example 5-3 are comparative examples.

The configuration of the cable with connector produced in each experimental example will be described below.

### Experimental Example 1-1

A cable including a plurality of coaxial electrical wires having the configuration shown in Table 1 was prepared as the plurality of electrical wires. In Table 1, the annealed copper wire that is the material of the central conductor means an annealed copper wire that is not plated. A stranded wire is used as the central conductor of the coaxial electrical wire. The plurality of electrical wires are twisted together to form a core, and the securing windings, the common shielding layer, and the outer covering shown in Table 1 are disposed in this order outside the core. The cable includes two coaxial electrical wires as a pair. Then, USB Type-C connectors are attached to both ends of the cable to form a cable with connector.

The cable with connector and the isolated cable thus obtained were evaluated for attenuation as described above. The attenuation evaluation result in 10 GHz is shown in Table 1.

### Experimental Example 1-2, Experimental Example 1-3

The central conductor of the coaxial electrical wire included in the cable was changed to the material shown in Table 1. A cable with connector was produced under the same conditions as in experimental example 1-1 except for the above points, and attenuation was evaluated. The evaluation result are shown in Table 1.

### Experimental Example 2-1 to Experimental Example 2-3, Experimental Example 3-1 to Experimental Example 3-3, Experimental Example 4-1 to Experimental Example 4-3, Experimental Example 5-1 to Experimental Example 5-3

The size and material of the central conductor were changed to the size and material shown in Table 1. A cable with connector was produced under the same conditions as in experimental example 1-1 except for the above points, and attenuation was evaluated. The evaluation result are shown in Table 1.

TABLE 1

| | | | CONFIGURATION OF CABLE | | | |
|---|---|---|---|---|---|---|
| | | | COAXIAL ELECTRICAL WIRE | | | |
| | EVALUATION RESULT | | CENTRAL CONDUCTOR | | | |
| | | ATTENUATION | | | CONDUCTOR | |
| | | OF ISOLATED | | | CROSS- | |
| | ATTENUATION | CABLE | | | SECTIONAL | |
| | (dB/m) | (dB/m) | | | AREA | |
| | (10 GHz) | (10 GHz) | MATERIAL | SIZE | (mm²) | INSULATOR |
| EXPERIMENTAL | 7.5 | 5.7 | ANNEALED | AWG30 | 0.05067 | FEP |
| EXAMPLE 1-1 | | | COPPER WIRE | | | |
| EXPERIMENTAL | 7.4 | 5.6 | SILVER-PLATED | | | |
| EXAMPLE 1-2 | | | ANNEALED | | | |
| | | | COPPER WIRE | | | |
| EXPERIMENTAL | 8.1 | 6.2 | TIN-PLATED | | | |
| EXAMPLE 1-3 | | | ANNEALED | | | |
| | | | COPPER WIRE | | | |
| EXPERIMENTAL | 8.2 | 7.7 | ANNEALED | AWG32 | 0.03243 | |
| EXAMPLE 2-1 | | | COPPER WIRE | | | |
| EXPERIMENTAL | 8.1 | 7.6 | SILVER-PLATED | | | |
| EXAMPLE 2-2 | | | ANNEALED | | | |
| | | | COPPER WIRE | | | |
| EXPERIMENTAL | 8.8 | 8.3 | TIN-PLATED | | | |
| EXAMPLE 2-3 | | | ANNEALED | | | |
| | | | COPPER WIRE | | | |
| EXPERIMENTAL | 6.3 | 4.9 | ANNEALED | AWG28 | 0.08046 | |
| EXAMPLE 3-1 | | | COPPER WIRE | | | |
| EXPERIMENTAL | 6.2 | 4.8 | SILVER-PLATED | | | |
| EXAMPLE 3-2 | | | ANNEALED | | | |
| | | | COPPER WIRE | | | |
| EXPERIMENTAL | 6.9 | 5.4 | TIN-PLATED | | | |
| EXAMPLE 3-3 | | | ANNEALED | | | |
| | | | COPPER WIRE | | | |
| EXPERIMENTAL | 5.3 | 4.2 | ANNEALED | AWG26 | 0.1281 | |
| EXAMPLE 4-1 | | | COPPER WIRE | | | |
| EXPERIMENTAL | 5.2 | 4.1 | SILVER-PLATED | | | |
| EXAMPLE 4-2 | | | ANNEALED | | | |
| | | | COPPER WIRE | | | |
| EXPERIMENTAL | 5.9 | 4.7 | TIN-PLATED | | | |
| EXAMPLE 4-3 | | | ANNEALED | | | |
| | | | COPPER WIRE | | | |
| EXPERIMENTAL | 13 | 11.5 | ANNEALED | AWG36 | 0.01267 | |
| EXAMPLE 5-1 | | | COPPER WIRE | | | |
| EXPERIMENTAL | 12 | 11.0 | SILVER-PLATED | | | |
| EXAMPLE 5-2 | | | COPPER WIRE | | | |
| EXPERIMENTAL | 15 | 12.5 | TIN-PLATED | | | |
| EXAMPLE 5-3 | | | ANNEALED | | | |
| | | | COPPER WIRE | | | |

| | CONFIGURATION OF CABLE | | | | | |
|---|---|---|---|---|---|---|
| | COAXIAL ELECTRICAL WIRE | | | | | |
| | EXTERNAL CONDUCTOR | | | | | |
| | FIRST | SECOND | | | COMMON | |
| | EXTERNAL | EXTERNAL | OUTER | SECURING | SHIELDING | OUTER |
| | CONDUCTOR | CONDUCTOR | COVERING | WINDINGS | LAYER | COVERING |
| EXPERIMENTAL | TIN- | COPPER- | POLYESTER | ALUMINUM- | TIN- | TPE |
| EXAMPLE 1-1 | PLATED | VAPOR- | TAPE | ATTACHED | PLATED | |
| EXPERIMENTAL | ANNEALED | DEPOSITED | | POLYESTER | ANNEALED | |
| EXAMPLE 1-2 | COPPER | POLYESTER | | TAPE | COPPER | |
| | WIRE | TAPE | | | WIRE | |
| EXPERIMENTAL | | | | | | |
| EXAMPLE 1-3 | | | | | | |
| EXPERIMENTAL | | | | | | |
| EXAMPLE 2-1 | | | | | | |
| EXPERIMENTAL | | | | | | |
| EXAMPLE 2-2 | | | | | | |
| EXPERIMENTAL | | | | | | |
| EXAMPLE 2-3 | | | | | | |
| EXPERIMENTAL | | | | | | |
| EXAMPLE 3-1 | | | | | | |
| EXPERIMENTAL | | | | | | |
| EXAMPLE 3-2 | | | | | | |
| EXPERIMENTAL | | | | | | |
| EXAMPLE 3-3 | | | | | | |
| EXPERIMENTAL | | | | | | |
| EXAMPLE 4-1 | | | | | | |
| EXPERIMENTAL | | | | | | |
| EXAMPLE 4-2 | | | | | | |
| EXPERIMENTAL | | | | | | |
| EXAMPLE 4-3 | | | | | | |
| EXPERIMENTAL | | | | | | |
| EXAMPLE 5-1 | | | | | | |
| EXPERIMENTAL | | | | | | |
| EXAMPLE 5-2 | | | | | | |
| EXPERIMENTAL | | | | | | |
| EXAMPLE 5-3 | | | | | | |

According to the results shown in Table 1, it was confirmed that attenuation was reduced and electrical characteristics were excellent by using an annealed copper wire that was not plated as the central conductor of the coaxial electrical wire, compared to the case of using a tin-plated annealed copper wire in which the conductor cross-sectional area of the central conductor was the same. In addition, it was confirmed that attenuation equivalent to that of the silver-plated annealed copper wire was realized by using the annealed copper wire that is not plated as the central conductor, and the material cost was able to be reduced. It was also confirmed that the above tendency was the same regardless of the size of the central conductor.

### REFERENCE SIGNS LIST

10 cable with connector
11 connector
1101 first cover
1102 second cover
111 substrate
1111 contact
1112 conductor
1113 region
20 cable
200 core
112 terminal
21 electrical wire
22 coaxial electrical wire
221 central conductor
222 insulator
223 external conductor
2231 first external conductor
2232 second external conductor
224 outer covering
23 insulating electrical wire
231 conductor
232 insulator
24 securing windings
25 common shielding layer
26 outer covering

1. A cable with a connector, comprising:
the connector; and
the cable,
wherein the cable includes a plurality of electrical wires including a coaxial electrical wire,
wherein the coaxial electrical wire includes a central conductor being an annealed copper wire that is not plated and having a conductor cross-sectional area of 0.031 mm² to 0.06 mm²,
wherein the connector includes a substrate, and the cable is connected to a contact part of the substrate, and
wherein an attenuation of the coaxial electrical wire is 5.1 dB/m to 8.1 dB/m.

2. A cable with a connector, comprising:
the connector; and
the cable,
wherein the cable includes a plurality of electrical wires including a coaxial electrical wire,
wherein the coaxial electrical wire includes a central conductor being an annealed copper wire that is not plated and having a conductor cross-sectional area of 0.07 mm² to 0.13 mm²,
wherein the connector includes a substrate, and the cable is connected to a contact part of the substrate, and
wherein an attenuation of the coaxial electrical wire is 4.0 dB/m to 5.0 dB/m.

3. A cable with a connector, comprising:
the connector; and
the cable,
wherein the cable includes a plurality of electrical wires including a coaxial electrical wire,
wherein the coaxial electrical wire includes a central conductor being an annealed copper wire that is not plated having a conductor cross-sectional area of 0.01 mm² to 0.025 mm²,
wherein the connector includes a substrate, and the cable is connected to a contact part of the substrate, and
wherein an attenuation of the coaxial electrical wire is 10 dB/m to 12 dB/m.

4. The cable with the connector according to claim 1,
wherein the cable includes at least one pair of coaxial electrical wires, and
wherein a skew of the pair of coaxial electrical wires is 10 ps/m or less.

5. The cable with the connector according to claim 1,
wherein the cable includes
a core constituted by twisting together the plurality of electrical wires,
a common shielding layer disposed outside the core, and
an outer covering disposed outside the common shielding layer.

6. The cable with the connector according to claim 1,
wherein the coaxial electrical wire includes an external conductor disposed outside the central conductor, and the external conductor includes an annealed copper wire that is not plated.

7. The cable with the connector according to claim 2,
wherein the cable includes at least one pair of coaxial electrical wires, and
wherein a skew of the pair of coaxial electrical wires is 10 ps/m or less.

8. The cable with the connector according to claim 2,
wherein the cable includes
a core constituted by twisting together the plurality of electrical wires,
a common shielding layer disposed outside the core, and
an outer covering disposed outside the common shielding layer.

9. The cable with the connector according to claim 2,
wherein the coaxial electrical wire includes an external conductor disposed outside the central conductor, and the external conductor includes an annealed copper wire that is not plated.

10. The cable with the connector according to claim 3,
wherein the cable includes at least one pair of coaxial electrical wires, and
wherein a skew of the pair of coaxial electrical wires is 10 ps/m or less.

11. The cable with the connector according to claim 3,
wherein the cable includes
a core constituted by twisting together the plurality of electrical wires,
a common shielding layer disposed outside the core, and
an outer covering disposed outside the common shielding layer.

12. The cable with the connector according to claim 3,
wherein the coaxial electrical wire includes an external conductor disposed outside the central conductor, and the external conductor includes an annealed copper wire that is not plated.
